(19) United States
(12) Patent Application Publication
(10) Pub. No.: US 2003/0170374 A1
(43) Pub. Date: Sep. 11, 2003

(54) Condiments including nutritional supplements

(76) Inventor: Robert Bahoshy, Long Beach, CA (US)

Correspondence Address: Peng Chen, Morrison & Foerster LLP, Suite 500, 3811 Valley Centre Drive, San Diego, CA, 92130-2332, US

(21) Appl. No.: 10/354,158

(22) Filed: Jan. 28, 2003

Related U.S. Application Data
(60) Provisional application No. 60/362,505, filed on Mar. 5, 2002.

(51) Int. Cl. A23L 1/221

(52) U.S. Cl. 426/650

(57) ABSTRACT

This invention provides an enhanced condiment, comprising an essentially dry particulate non-sweet flavoring agent and at least one proteoglycan precursor and effective salts. This invention also provides An enhanced condiment, comprising a non-solid matrix condiment, and at least one proteoglycan precursor and effective salts. This invention further provides a method for making an enhanced condiment comprising, combining an essentially dry particulate non-sweet flavoring agent with, at least one proteoglycan precursor and effective salts. Finally, this invention provides a method of making an enhanced condiment comprising, combining a non-solid liquid matrix condiment with, at least one proteoglycan precursor and effective salts thereof.

This application claims the benefit of Provisional Patent Application No. 60/362,505, Filed Mar. 5, 2002 under 35 U.S.C. § 119(e). The content of the above-referenced application is incorporated herein in their entireties.

Throughout this application, various references are referred to. Disclosures of these publications in their entireties are hereby incorporated by reference into this application to more fully describe the state of the art to which this invention pertains.

### FIELD OF THE INVENTION

The present invention relates generally to condiments used for flavoring foods. In particular, the present invention relates to flavoring agents commonly used in the preparation of food products as well as condiments used to season and improve the taste of foods after preparation. Additionally, the present invention relates to methods for making these condiments.

### BACKGROUND OF THE INVENTION

Almost all consumable food products used today will have a condiment, such as a flavoring agent, added to it at some point prior to consumption. It is quite common to modify the taste of food products in order to make them more palatable. Since ancient times, the use of condiments, such as spices has played a major role in civilization. When Europe first developed its appetite for spices, it developed spice routes through the Middle East. Much of this spice trade was initially controlled by the city of Venice and as the prices rose, other European powers, such as Spain, the Netherlands and Portugal sought alternative routes to the spice producing regions of the East Indies. Many of the voyages undertaken by European explorers arose from the need to find alternative spice routes exemplified by Columbus' voyage in 1492 in search of the Indies.

The reasons for the opening of spice routes from Europe through the Middle East and into Asia, largely arose from the desire of Europeans to have access to these condiments. Their chief benefits were two-fold. One primary purpose of condiments was for the flavoring foods, especially prior to our ability to maintain foods in a refrigerated state. The condiments then allowed foods that were not in their freshest state to be seasoned in a way that would mask any undesirable taste or odor. In this way, condiments functioned to flavor foods. A secondary benefit derived from condiments was also discovered in their ability to preserve certain perishables for extended periods.

Of particular interest in the condiment industry is Sodium chloride, otherwise know as common table salt. This product is widely used by most food manufacturers to flavor their products and to add other desirable properties to their products, such as a longer shelf life.

Other condiments, especially of the particulate, powdered or dry varieties are found in most homes for the preparation of food. These may include flavorants derived from either mineral sources, or from organic matter, such as plants. Some of the most common sources include dried plants and herbs that have had their water content lowered close to zero to prevent spoilage and allow for long-term storage. These may be purchased in some type of dispensing container, thereby allowing the user to purchase the product in a ready-to-use form and use small portions to flavor their foods. In addition, condiments may be sold in bulk amounts, especially for users in the food industry such as restaurants, cafeterias and government agencies.

Condiments are not limited to dry particulate spices and seasonings but also include a wide range of food additives, sauces, dips, spreads and other methods of flavoring food including non-solid condiments. These condiments are used to enhance flavor or help create flavor in all types of food products. Non-solid matrix condiments are ubiquitous in the everyday human diet and are present in almost every meal. For example, for breakfast one may use creamer in their coffee in the morning, along with a margarine spread on their toast; lunch may include a salad with dressing or a sandwich with ketchup or mustard; and dinner may require any number of sauces and marinades to enhance the flavor of the prepared food.

Condiments are also rapidly expanding beyond the traditional industry leaders of ketchup and mustard. One such example of the new range of condiments used by consumers is the growing appetite for salsa and other spicy Mexican sauces. Salsa recently surpassed ketchup as America's best-selling condiment, with annual sales of $700 million and is used throughout the United States.

Although the use of such condiments has been well know for centuries, the additional benefits, as well as detriments, of these products has recently been given greater attention. In the case of salt, a reduction it its consumption is sought by many experts due its link with high blood pressure and heart disease. This has led to the proliferation of Sodium Chloride salt substitutes, mostly based on Potassium Chloride. On the other hand, many spices and herbs have been found to provide medicinal benefits to consumers in the form of antioxidants, blood pressure regulation and a number of ever-growing uses brought about by the inherent chemical compounds found in these condiments.

In addition to their inherent beneficial qualities, some common condiments are also used as delivery vehicles for important nutrients that are often lacking in the everyday human diet. An example of such use is iodized table salt. Before 1924 it is estimated that 10-15% of the United States population suffered from iodine deficiency. In response, salt producers, in cooperation with public health authorities, made both iodized and plain salt available to consumers at the same cost. Consumers began to purchase iodized salt for its health benefits and ultimately, household use of iodized salt eliminated iodine deficiency in North America.

Because condiments are so prevalent in the common diet, they are an excellent vehicle to provide consumers with important nutritional supplements, without requiring consumers to alter their eating habits. This use is especially relevant when the supplements are not found in the common diet and other delivery vehicles for the supplements take the form of unappealing tablets and pills. One such group of supplements is proteoglycan precursors, in particular, glucosamine and chondroitin.

Glucosamine and chondroitin are components of normal cartilage. Both act as precursors in the formation of proteoglycans which in turn become the building blocks of connective tissue. While glucosamine is a multifunctional precursor of proteoglycan synthesis in general and glycosaminoglycans in particular, chondroitin is a glycosaminoglycan that is preferentially incorporated into cartilaginous tissue. Because of its tropism for cartilage, chondroitin is the most abundant glycosaminoglycan in cartilage and is responsible for the resiliency of joint tissue.

Over the past two decades, an alternative treatment for joint related ailments has emerged. The alternative treatment involves administering glucosamine and chondroitin supplements to patients suffering from joint related ailments. These two proteoglycan precursors represent a proactive treatment for treating and maintaining joint health. Recently they have demonstrated pain relief effects in arthritic patients and may even reverse the effects of arthritis and assist the body to repair and rehabilitate damaged cartilage. Unlike other medications, they have no known side effects.

While the body normally generates enough proteoglycan precursors to maintain levels of cartilage throughout, many people suffering from arthritis require supplements of these very important compounds. However, it is difficult to supplement their intake merely by a change in diet because the sources of glucosamine and chondroitin are not commonly found in foods. In particular, glucosamine is normally derived and isolated-from chitin but may be derived from other organic/botanical sources. Chitin is a major component of the shells of sea animals such as crab and sea shrimp. Edible chondroitin on the other hand is normally derived from animal connective tissue such as tendons, cartilage and trachea, while proteoglycan precursors may be derived from other organic/botanical sources.

Because of the difficulty of including these items in a normal diet, glucosamine and chondroitin commonly require administration through oral supplements. Common oral supplements take the form of capsules, tablets or pills. Similar supplements are disclosed in U.S. Pat. Nos. 6,255,295, 6,162,787, and 5,840,715, among others. These types of delivery methods often fail because many people have difficulty taking pills, dislike taking them or forget to take enough to meet the effective dosage. Of particular interest is the elderly community, which commonly suffers from difficulties ingesting foods and nutrients. Many of their medications must be administered via liquid diets and/or intravenously. The following invention seeks to solve these problems by incorporating proteoglycan precursor supplements into common condiments used in every meal and that may be easily ingested by both young and old.

### SUMMARY OF THE INVENTION

Due to the existing need for a product that supplements chondroitin and/or glucosamine intake by persons in need of such supplementation, a brief summary of the present invention is presented. Some simplifications and omissions may be made in the following summary, which is intended to highlight and introduce some aspects of the present invention, but not limit its scope. Detailed descriptions of a preferred exemplary embodiment adequate to allow those of ordinary skill in the art to make and use the invention concepts will follow in later sections.

An enhanced condiment product is disclosed which generally comprises an essentially dry particulate flavoring agent with the addition of a proteoglycan precursor. Additionally, a method is disclosed for making an enhanced condiment by combining an essentially dry particulate flavoring agent along with a proteoglycan precursor.

An enhanced condiment is disclosed which generally comprises a non-solid matrix condiment combined with a proteoglycan precursor.

Additionally, a method is disclosed for making an enhanced condiment which generally comprises a non-solid matrix condiment along with a proteoglycan precursor.

### DESCRIPTION OF EXEMPLARY EMBODIMENTS

Dry particulate flavoring agents may include, but are not limited to, Allspice, Anise, Basil, Bay Leaves, Caraway, Cardamom, Celery, Chervil, Chili Powder, Chives, Cilantro, Cinnamon, Cloves, Coriander, Cumin, Curry Powder, Dill Seed, Dill Weed, Fennel, Fenugreek, Garlic, Ginger, Jalapenos, Mace, Marjoram, Mustard, Non-dairy creamer, Nutmeg, Onion, Oregano, Paprika, Parsley, Black Pepper, Red Pepper, White Pepper, Poppy Seed, Rosemary, Saffron, Sage, Salt Substitutes, Sesame, Sodium Chloride, Spearmint, Spice Blends, Tarragon, Thyme, Turmeric, Wasabi and combinations thereof.

Salt substitutes are products that are designed to be used in the place of Sodium Chloride. These include compositions that include constituents such as Potassium Chloride, Sodium Sulfite and Sodium BiSulfite and Monosodium Glutamate (MSG). Non-solid matrix condiments can include, but are not limited to, sauces, dips, spreads, dressings, batters, glazes, marinades, coatings, seasonings, creamers, pastes or rubs.

Specific condiments that may be combined with the proteoglycan precursor include, but are not limited to: ketchups, mustards, barbecue sauces, salsas, soy sauces, dairy creamers, non-dairy creamers, steak sauces, Worcestershire sauces, butters, margarines, cream cheeses, cottage cheeses, cheese sauces, all varieties of salad dressings, cooking oils, peanut butter and peanut spread.

The examples below exemplify some of the embodiments that may be formulated according to the present invention. While some of these condiments may be used to fully supplement a person's daily intake of these proteoglycans precursors, others may be part of a complete supplementation program. In such a program, the total recommended supplementation amount may be fulfilled by more than one condiment. Additionally, the use of these condiments may be applied to veterinary uses, in order to supplement the needs of animals in need of such supplements.

### EXAMPLE 1

DRY NON-DAIRY CREAMER

| serving size(g) | 2 | | |
|---|---|---|---|
| Ingredients | % | ranges(g) | amount(g) |
| vegetable fat | 29.0 | 0.2-0.8 | 0.580 |
| corn syrup solids | 29.0 | 0.2-0.8 | 0.580 |
| dry sweet whey | 30.5 | 0.2-0.10 | 0.609 |
| sodium caseinate | 4.0 | 0-0.16 | 0.080 |
| dipotassium phosphate | 1.5 | 0-0.06 | 0.030 |
| mono and diglycerides | 0.7 | 0-0.026 | 0.013 |
| gum stabilizer | 0.3 | 0-0.12 | 0.006 |
| FSI N&A cream flavor | 0.1 | 0-0.004 | 0.002 |
| proteoglycan precursors | 5.0 | 0-0.2 | 0.100 |
| Total | 100 | | 2 |

### EXAMPLE 2

LIQUID NON-DAIRY CREAMER

| serving size(ml) | 15 | | |
|---|---|---|---|
| Ingredients | % | ranges(g) | amount(ml) |
| vegetable oil | 12.67 | 0-3.8 | 1.9000 |
| corn syrup | 14.20 | 0-4.0 | 2.1300 |
| sodium caseinate | 0.35 | 0-0.1 | 0.052 |
| ESI cream flavor | 0.10 | 0-0.03 | 0.0150 |
| mono and diglycerides | 0.50 | 0-0.15 | 0.0750 |
| polysorbate 60 or 80 | 0.10 | 0-0.03 | 0.0150 |
| dipostassium phosphate | 0.06 | 0-0.020 | 0.0090 |
| disodium phosphate | 0.06 | 0-0.020 | 0.0090 |
| sodium acid pyrophosphate | 0.30 | 0-0.09 | 0.0450 |
| water | 69.66 | 0-20 | 10.7000 |
| proteoglycan precursors | 2.00 | 0-0.1 | 0.3000 |
| total | 100.00 | | 15.250 |

### EXAMPLE 3

PREPARED MUSTARD

| serving size 1 tsp(g) | 5 | | |
|---|---|---|---|
| ingredients | % | ranges(g) | amount(g) |
| white distilled vinegar | 81.96 | 0-5.0 | 4.1000 |
| ground yellow mustard seeds | 12.50 | 0-2.0 | 0.6250 |
| salt(non-iodized) | 3.00 | 0-0.5 | 0.1500 |
| tumeric | 0.50 | 0-0.05 | 0.0250 |
| garlic powder | 0.02 | 0-0.002 | 0.0010 |
| cayenne pepper | 0.01 | 0-0.001 | 0.0005 |
| spice | 0.01 | 0-0.001 | 0.0005 |
| proteoglycan precursor | 2.00 | 0-0.2 | 0.1000 |
| total | 100.00 | | 5.0020 |

### EXAMPLE 4

MAYONNAISE

| serving size 1 tbsp(g) | 14 | | |
|---|---|---|---|
| ingredients | % | ranges(g) | amount(g) |
| FSI Mayonnaise Flavor | 1.00 | 0-0.5 | 0.140 |
| Soy bean oil | 81.4157 | 0-14.0 | 11.400 |
| Egg Yolks(frozen) | 7.00 | 0-2.0 | 0.980 |
| Wine(White) | 2.50 | 0-0.5 | 0.350 |
| Corn Syrup | 2.00 | 0-0.5 | 0.280 |
| Vinegar(200 gm) | 1.00 | 0-0.5 | 0.140 |
| Lemon Juice | 1.00 | 0-0.5 | 0.140 |
| Mustard Powder | 0.10 | 0-0.05 | 0.014 |
| Pepper(white) | 0.05 | 0-0.05 | 0.007 |
| Salt(granulated) | 1.07 | 0-0.3 | 0.150 |
| Water | 2.15 | 0-0.6 | 0.301 |
| proteoglycan precursors | 0.71 | 0-0.2 | 0.100 |
| total | 100.00 | | 14.002 |

### EXAMPLE 5

TOMATO KETCHUP

| serving size 1 tbsp(g) | 17 | | |
|---|---|---|---|
| ingredients | % | ranges(g) | amount(g) |
| FSI Tomato Flavor | 5.00 | 0-2.0 | 0.8500 |
| Tomato Paste(32%) | 36.49 | 0-10.0 | 6.203 |
| Vinegar(200 gm) | 5.00 | 0-2.0 | 0.8500 |
| Tomatoes(peeled & crushed) | 14.00 | 0-5.0 | 2.3800 |
| Vinegar Cider | 2.00 | 0-1.0 | 0.3400 |
| Corn Syrup | 25.00 | 0-8.0 | 4.2500 |
| Starch(modified food) | 0.50 | 0-0.2 | 0.0850 |
| Salt | 1.41 | 0-0.50 | 0.2400 |
| Onion Powder | 0.75 | 0-0.25 | 0.1275 |
| Garlic Powder | 0.10 | 0-0.040 | 0.0170 |
| Cayenne Pepper | 0.05 | 0-0.020 | 0.0085 |
| Allspice(ground) | 0.03 | 0-0.01 | 0.0051 |
| Clove(ground) | 0.03 | 0-0.01 | 0.0051 |
| Mustard(ground) | 0.05 | 0-0.02 | 0.0085 |
| Water | 9 | 0-3.0 | 1.5300 |
| proteoglycan precursors | 0.59 | 0-0.20 | 0.1000 |
| Total | 100 | | 17 |

### EXAMPLE 6

BARBECUE SAUCE

| serving size 2 tbsp(g) | 34 | | |
|---|---|---|---|
| ingredients | % | ranges(g) | amount(g) |
| FSI Barbecue Flavor | 1.50 | 0-1.0 | 0.5100 |
| Tomato Paste(31*) | 33.39 | 0-15.0 | 11.352 |
| Vinegar(300 gm) | 7.00 | 0-5.0 | 2.3800 |
| Corn Syrup | 41.00 | 0-20.0 | 13.9400 |
| Starch(modified food) | 0.50 | 0-0.4 | 0.1700 |
| Salt(granulated) | 1.91 | 0-1.0 | 0.6500 |
| Onion Powder | 1.75 | 0-1.0 | 0.5950 |
| Garlic Powder | 0.25 | 0-0.16 | 0.0850 |
| Cayenne Pepper | 0.05 | 0-0.04 | 0.0170 |
| Allspice(ground) | 0.03 | 0-0.02 | 0.0102 |
| Clove(ground) | 0.03 | 0-0.02 | 0.0102 |
| Mustard(ground) | 0.10 | 0-0.06 | 0.0340 |
| Worcestershire Sauce | 2.50 | 0-2.0 | 0.8500 |
| Chili Powder | 0.90 | 0-0.6 | 0.3060 |
| Tarragon Vinegar | 1 | 0-0.6 | 0.3400 |
| Water | 7.5 | 0-5.0 | 2.5500 |
| proteoglycan precursors | 0.59 | 0-0.4 | 0.2000 |
| total | 100 | | 3 |

### EXAMPLE 7

STEAK SAUCE

| | |
|---|---|
| serving size 1 tbsp(g) | 17 |

| ingredients | % | ranges(g) | amount(g) |
|---|---|---|---|
| FSI Steak Flavoring | 1.50 | 0-0.5 | 0.2550 |
| Autolyzed Yeast Extract | 3.50 | 0-1.0 | 0.5950 |
| HVP or Protein Source | 4.71 | 0-1.0 | 0.8000 |
| Tomato Paste(31*) | 28.00 | 0-10.0 | 4.7600 |
| Sugar or Corn Syrup | 17.00 | 0-5.0 | 2.8900 |
| Vinegar(cider & malt) | 12.00 | 0-5.0 | 2.0400 |
| Salt(granulated) | 1.01 | 0-0.4 | 0.1710 |
| Onion Powder | 0.50 | 0-0.2 | 0.0850 |
| Gum | 0.25 | 0-0.1 | 0.042 |
| Garlic Powder | 0.25 | 0-0.1 | 0.042 |
| Spice | 0.25 | 0-0.1 | 0.042 |
| Water | 28.95 | 0-10.0 | 4.921 |
| Oil | 1.00 | 0-0.4 | 0.1700 |
| Fruit Concentrate | 0.50 | 0-0.2 | 0.0850 |
| proteoglycan precursors | 0.59 | 0-0.2 | 0.1000 |
| total | 100 | | 17 |

What is claimed:

1. An enhanced condiment, comprising:
an essentially dry particulate non-sweet flavoring agent; and
at least one proteoglycan precursor and effective salts thereof.

2. An enhanced condiment according to claim 1, wherein the proteoglycan precursor is chondroitin and effective salts thereof.

3. An enhanced condiment according to claim 2, wherein the flavoring agent is sodium chloride.

4. An enhanced condiment according to claim 2, wherein the flavoring agent is a salt substitute.

5. An enhanced condiment according to claim 2, wherein the flavoring agent is pepper.

6. An enhanced condiment according to claim 2, wherein the flavoring agent is ginger

7. An enhanced condiment according to claim 2, wherein the flavoring agent is vanilla.

8. An enhanced condiment according to claim 2, wherein the flavoring agent is onion.

9. An enhanced condiment according to claim 2, wherein the flavoring agent is garlic.

10. An enhanced condiment according to claim 2, wherein the flavoring agent is a creamer.

11. An enhanced condiment according to claim 1, wherein the proteoglycan precursor is glucosamine and effective salts thereof.

12. An enhanced condiment according to claim 1, wherein the proteoglycan precursors are a combination of glucosamine and effective salts thereof and chondroitin and effective salts thereof.

13. An enhanced condiment, comprising:
a non-solid matrix condiment, and at least one
proteoglycan precursor and effective salts thereof.

14. An enhanced condiment according to claim 10, wherein a proteoglycan precursor is glucosamine and effective salts thereof.

15. An enhanced condiment according to claim 11 wherein the condiment is ketchup.

16. An enhanced condiment according to claim 11, wherein the condiment is mustard.

17. An enhanced condiment according to claim 11, wherein the condiment is a creamer (dairy/non dairy).

18. An enhanced condiment according to claim 11, wherein the condiment is a salsa.

19. An enhanced condiment according to claim 10, wherein a proteoglycan precursor is chondroitin and effective salts thereof.

20. An enhanced condiment according to claim 10, wherein the proteoglycan precursors are a combination of glucosamine and effective salts thereof and chondroitin and effective salts thereof.

21. A method for making an enhanced condiment comprising, combining an essentially dry particulate non-sweet flavoring agent with, at least one proteoglycan precursor and effective salts thereof.

22. A method according to claim 18, wherein the proteoglycan precursor is chondroitin and effective salts thereof.

23. A method according to claim 19, wherein the flavoring agent is sodium chloride.

24. A method according to claim 19, wherein the flavoring agent is a salt substitute.

25. A method according to claim 19, wherein the flavoring agent is pepper.

26. A method according to claim 19, wherein the flavoring agent is garlic.

27. A method according to claim 19, wherein the flavoring agent is ginger.

28. A method according to claim 19, wherein the flavoring agent is onion.

29. A method according to claim 19, wherein the flavoring agent is vanilla.

30. A method according to claim 19, wherein the flavoring agent is creamer.

31. A method according to claim 18, wherein the proteoglycan precursor is glucosamine and effective salts thereof.

32. A method according to claim 18, wherein the proteoglycan precursors are a combination of glucosamine and effective salts thereof and chondroitin and effective salts thereof.

33. A method of making an enhanced condiment comprising, combining a non-solid liquid matrix condiment with, at least one proteoglycan precursor and effective salts thereof.

34. A method according to claim 27, wherein a proteoglycan precursor is glucosamine and effective salts thereof.

35. A method according to claim 28 wherein the condiment is ketchup.

36. A method according to claim 28, wherein the condiment is mustard.

37. A method according to claim 28, wherein the condiment is a creamer (dairy/non dairy).

38. A method according to claim 28, wherein the condiment is a salsa.

39. A method according to claim 27, wherein a proteoglycan precursor is chondroitin and effective salts thereof.

40. A method according to claim 27, wherein the proteoglycan precursors are a combination of glucosamine and effective salts thereof and chondroitin and effective salts thereof.
